(19) United States
(12) Patent Application Publication
(10) Pub. No.: US 2026/0177090 A1
(43) Pub. Date: Jun. 25, 2026

(54) CONNECTION JOINT OF CLOSURE OFSPACE GRID AND TRUSS STRUCTURE AND CONSTRUCTION METHOD THEREOF

(71) Applicants: CHINA RAILWAY NO.4 ENGINEERING GROUP CO., LTD, Hefei (CN); THE CONSTRUCTION ENGINEERING COMPANY OF CTCE GROUP, Hefei (CN); Hefei University of Technology, Hefei (CN)

(72) Inventors: Hongyao GONG, Hefei (CN); Xudong SHENG, Hefei (CN); Ruixue CAO, Hefei (CN); Jingfeng WANG, Hefei (CN); Beibei LI, Hefei (CN); Ao LIU, Hefei (CN); Bin DU, Hefei (CN); Zhizhen HUANG, Hefei (CN); Deyuan HU, Hefei (CN); Yongli LIU, Hefei (CN); Yuan GAO, Hefei (CN)

(21) Appl. No.: 18/846,418

(22) PCT Filed: Jun. 21, 2024
(86) PCT No.: PCT/CN2024/100573

§ 371 Date: Sep. 12, 2024

(30) Foreign Application Priority Data
Jul. 6, 2023 (CN) 202310824508.2

(51) Int. Cl. F16B 5/00; E04B 1/26; E04C 3/04; E04C 3/07; E04C 3/08; E04C 3/16; E04C 3/17; E04C 3/28

(52) U.S. Cl. CPC F16B 5/00; E04B 1/2608; E04C 3/07; E04C 3/08; E04C 3/16; E04C 3/17; E04C 3/28; E04C 2003/0491; E04C 2003/0495

(57) ABSTRACT

A connection joint of closure of a space grid and a truss structure, including a grid chord, a truss chord, and a sleeve. The sleeve is sleeved on the truss chord, circumferential long slotted holes are formed on the truss chord, and the sleeve is connected to the circumferential long slotted holes through one-sided bolts. Grid chord tie plates are welded to the grid chord, and grid chord butting plates are welded to right ends of the grid chord tie plates. Sleeve tie plates are welded to the sleeve, and sleeve butting plates are welded to right ends of the sleeve tie plates. The grid chord tie plates are connected to the sleeve tie plates through tension bolts, and the grid chord butting plates are connected to the sleeve butting plates through splicing plates.

### TECHNICAL FIELD

The present disclosure relates to the field of truss structures, and in particular to a connection joint of closure of a space grid and a truss structure.

### BACKGROUND

With the development of economy and society and the improvement of civil engineering construction and scientific research level in China, long-span space grid and truss structures are widely used in public buildings such as stadiums, convention centers, high-speed railway station buildings and airport terminals, which effectively promote the further development of local economy, sports, and cultural tourism.

In order to give full play to the lightness and construction convenience of the grid structures, long-span characteristics of pipe truss structures and advantages of arbitrary curved surface modeling, long-span space grid-truss hybrid structure has begun to be applied to the buildings that need large bay and space, such as the high-speed railway station buildings.

Chords and web members of the space grid structure are generally connected through bolted balls or welded balls, while chords and web members of the space tube truss structure are generally connected through welded tube joints. Due to different connection modes of members of two types of space structure systems and manufacturing and construction errors, position deviation of chords of the grid-truss hybrid structure at closures is large, and accuracy cannot meet requirements of bolted connection, so butt welding is generally adopted as the connection mode of the chords of the grid-truss hybrid structure at the points of closure. Hydraulic jacks and stacking plates are generally used for forced position correction by construction units, and then used for high-altitude butt welding. However, there are many problems in the construction site, such as large amount of butt welding of members, high difficulty in high-altitude welding, high welding cost, serious stress concentration at the weld, and difficult guarantee of welding quality. Therefore, there is an urgent need to provide an efficient and safe connection method suitable for the closure of a long-span space grid-truss hybrid structure.

Therefore, how to develop a novel connection joint of closure of a space grid and a truss structure has become an urgent problem for those skilled in the art.

### SUMMARY

An objective of the present disclosure is to provide a connection joint of closure of a space grid and a truss structure, technical problems in construction of a connection joint of a grid and a truss are solved, and problems of low construction efficiency, poor adjustment performance and poor bending resistance in the construction of joint connection are solved.

To achieve the objective above, the present disclosure adopts the following technical solution:

A connection joint of closure of a space grid and a truss structure, comprising a grid chord, a truss chord and a sleeve, wherein the sleeve is sleeved on the truss chord, a circumferential surface of the truss chord is provided with circumferential long slots in fit with the sleeve, and the sleeve is connected to the circumferential long slots through one-sided bolts; grid chord tie plates are welded to the grid chord, and grid chord butting plates are welded to right ends of the grid chord tie plates; sleeve tie plates are welded to the sleeve, and sleeve butting plates are welded to right ends of the sleeve tie plates; and the grid chord tie plates are connected to the sleeve tie plates through tension bolts, and the grid chord butting plates are connected to the sleeve butting plates through splicing plates.

Further, each splicing plate is provided with a plurality of longitudinal long slots, each grid chord butting plate is provided with bolt holes in fit with the longitudinal long slots, and each grid chord butting plate is connected to the longitudinal long slots in a corresponding one of the splicing plates through high-strength bolts; each sleeve butting plate is provided with bolt holes in fit with the longitudinal long slots, and each sleeve butting plate is connected to the longitudinal long slots in a corresponding one of the splicing plates through the high-strength bolts.

Further, grid chord reinforcement ribs are welded to left ends of the grid chord tie plates, and sleeve reinforcement ribs are welded to left ends of the sleeve tie plates.

Further, the grid chord tie plates are provided with first bolt holes in fit with the tension bolts, and the sleeve tie plates are provided with second bolt holes in fit with the tension bolts.

Further, the grid chord tie plates are fan-shaped, four grid chord tie plates are circumferentially welded to a circumferential surface of the grid chord with an angle of 90° between each two adjacent grid chord tie plates; and the sleeve tie plates are fan-shaped, four sleeve tie plates are circumferentially welded to the sleeve with an angle of 90° between each two adjacent sleeve tie plates.

Further, each splicing plate is provided with four longitudinal long slots.

Further, the grid chord reinforcement ribs and the grid chord butting plates are trapezoidal, and the grid chord reinforcement ribs and the grid chord butting plates are vertically welded to left and right ends of the grid chord tie plates, respectively; and the sleeve reinforcement ribs and the sleeve butting plates are trapezoidal, and the sleeve reinforcement ribs and the sleeve butting plates are vertically welded to left and right ends of the sleeve tie plate, respectively.

Further, an outer diameter of the grid chord is the identical with an outer diameter of the truss chord, and an inner diameter of the sleeve is greater than an outer diameter of the truss chord.

Further, lower end surfaces of the grid chord reinforcement ribs and lower end surfaces of the grid chord butting plates are correspondingly welded to upper surfaces of the grid chord tie plates, and lower surfaces of the grid chord tie plates are flush with a lower end surface of the grid chord; lower end surfaces of the sleeve reinforcement ribs and lower end surfaces of the sleeve butting plates are correspondingly welded to upper surfaces of the sleeve tie plates; upper end surfaces of the sleeve reinforcement ribs and upper end surfaces of the sleeve butting plates are flush with an upper end surface of the sleeve, and lower surfaces of the sleeve tie plates are not flush with a lower end surface of the sleeve.

A construction method for a closure connection joint of a space grid and a truss structure includes the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

Compared with the prior art, the present disclosure has beneficial effects as follows:
1. The space grid chord and the truss chord are in bolted connection, with high assembly efficiency, and safe and reliable connection. Problems of heavy workload, difficult guarantee of welding quality and high welding cost in high-altitude butt welding are avoided.
2. The circumferential long slotted hole are formed in the truss chord, such that the sleeve can make limited circumferential rotation along the truss chord, so as to solve a problem that the bolted connection cannot be achieved caused by a situation that grid chord tie plates as well as reinforcement ribs and butting plates thereof and sleeve tie plate as well as reinforcement ribs and butting plates thereof are not aligned due to a construction error between the grid chord and the truss chord.
3. The longitudinal butting of the grid chord and the truss chord is achieved through the tension bolts. When there is a gap between the grid chord and the truss chord due to construction error, the gap can be adjusted through the long longitudinal slotted holes formed on the splicing plates, thus splicing connection between the splicing plates and the grid chord butting plates and splicing connection between the splicing plates and the sleeve butting plates are achieving achieved.
4. An axial load between the grid chord and the truss chord is borne and transferred through the tension bolt, and a bending moment and a shear force are borne and transferred by the splicing plates, so the force is clear, and the design is convenient.

### BRIEF DESCRIPTION OF THE DRAWINGS

The present disclosure is further described below with reference to accompanying drawings:

FIG. 1 is an exploded view of a connection joint of closure of a space grid and a truss structure according to the present disclosure;

FIG. 2 is a fitting diagram of a splicing plate and a grid chord;

FIG. 3 is an axonometric diagram of a sleeve;

FIG. 4 is a front view of a truss chord;

FIG. 5 is a top view of a grid chord;

FIG. 6 is a top view of a sleeve;

FIG. 7 is a connection diagram of a connection joint of closure of a space grid and a truss structure according to the present disclosure;

Numeral references are as follows: 1—grid chord; 2—truss chord; 3—sleeve; 4—grid chord tie plate; 5—sleeve tie plate; 6—grid chord stiffener; 7—sleeve stiffener; 8—grid chord butting plate; 9—sleeve butting plate; 10—splicing plate; 11—one-sided bolt; 12—high-strength bolt; 13—tension bolt; 14—longitudinal long slotted hole; 15—first bolt hole; 16—circumferential long slotted hole; 17—second bolt hole.

### DETAILED DESCRIPTION OF THE EMBODIMENTS

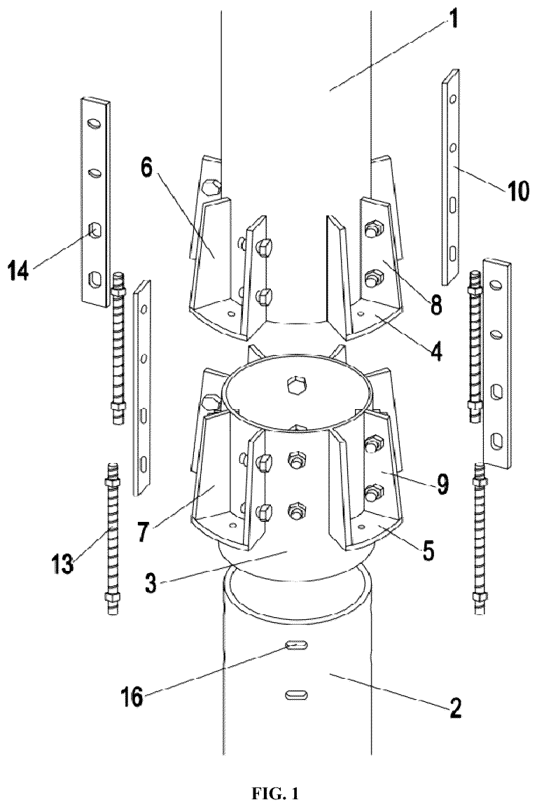

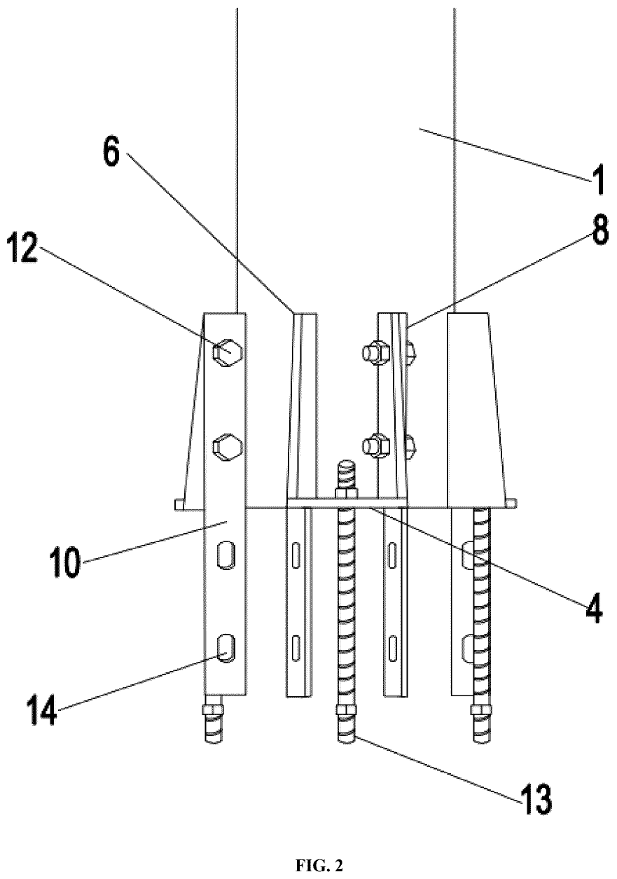

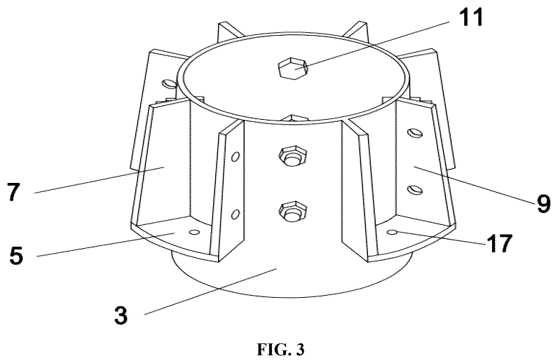

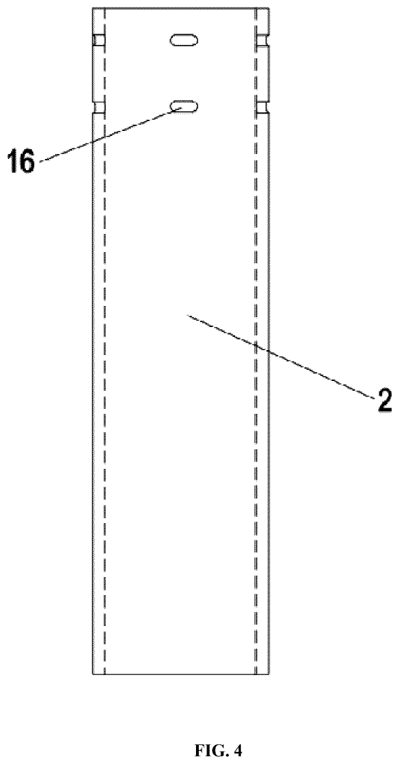

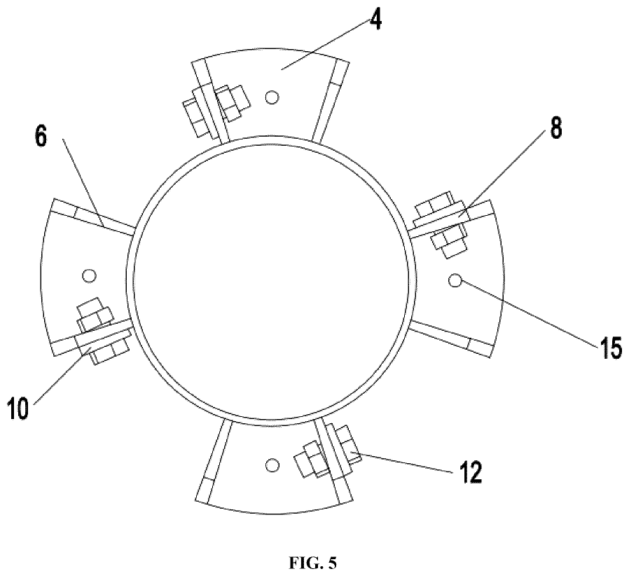

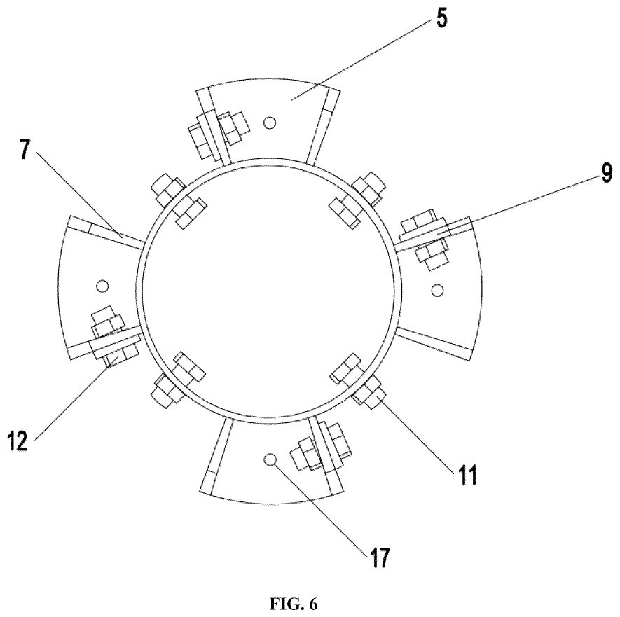

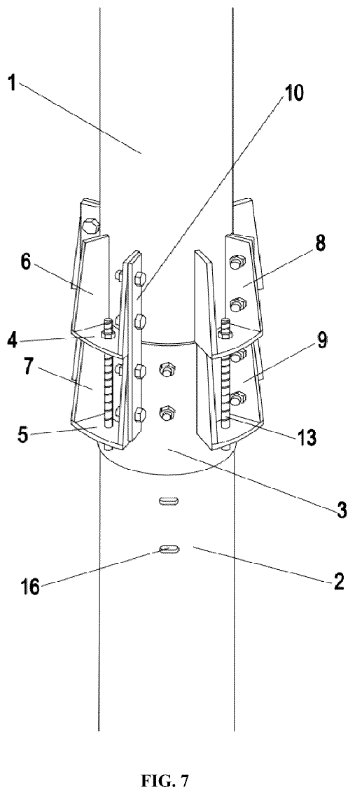

As shown in FIG. 1 to FIG. 7, a connection joint of closure of a space grid and a truss structure includes a grid chord 1, a truss chord 2, and a sleeve 3. An outer diameter of the grid chord 1 is the same as that of the truss chord 2, and an inner diameter of the sleeve 3 is greater than the outer diameter of the truss chord 2.

The sleeve 3 is sleeved on the truss chord 2, a circumferential surface of the truss chord 2 is provided with circumferential long slotted holes 16 in fit with the sleeve 3, and the sleeve 3 is connected to the circumferential long slotted holes 16 through one-sided bolts 11.

Four groups of circumferential long slotted holes 16 are distributed around the truss chord 2 at an angle of 90°, and each group of circumferential long slotted holes 16 includes two circumferential long slotted holes 16 which are arranged vertically.

Bolt holes, corresponding to the circumferential long slotted holes 16, of the sleeve 3 are formed on an empty position of the sleeve tie plate 5, thus avoiding affecting the installation of tension bolts 13.

Grid chord tie plates 4 are welded to the grid chord 1, and grid chord butting plates 8 are welded to right ends of the grid chord tie plates 4. Sleeve tie plates 5 are welded to the sleeve 3, and sleeve butting plates 9 are welded to right ends of the sleeve tie plates 5. Grid chord stiffener 6 are welded to left ends of the grid chord tie plates 4, and sleeve reinforcement ribs 7 are welded to left ends of the sleeve tie plates 5.

Specifically, the grid chord tie plates 4 are fan-shaped, and four grid chord tie plates 4 are circumferentially welded to a circumferential surface of the grid chord 1 with an angle of 90° between each two adjacent grid chord tie plates 4. The sleeve tie plates 5 are fan-shaped, and four sleeve tie plates 5 are circumferentially welded on the sleeve 3 with an angle of 90° between each two adjacent sleeve tie plates.

Specifically, the grid chord reinforcement ribs 6 and the grid chord butting plates 8 are both trapezoidal, and the trapezoidal shape can bear a shear force and a bending moment better, and thus materials can be saved better, the expense can be reduced, and the shape is more visually pleasurable. The grid chord reinforcement ribs 6 and the grid chord butting plates 8 are vertically welded to left and right ends of the grid chord tie plates 4, respectively. The sleeve reinforcement ribs 7 and the sleeve butting plates 9 are both trapezoidal, and the sleeve reinforcement ribs 7 and the sleeve butting plates 9 are vertically welded to left and right ends of the sleeve tie plate 5, respectively.

Lower end surfaces of the grid chord reinforcement ribs 6 and lower end surfaces of the grid chord butting plates 8 are correspondingly welded to upper surfaces of the grid chord tie plates 4, and lower surfaces of the grid chord tie plates 4 are flush with a lower end surface of the grid chord 1. Lower end surfaces of the sleeve reinforcement ribs 7 and lower end surfaces of the sleeve butting plates 9 are welded to upper surfaces of the sleeve tie plates 5. Upper end surfaces of the sleeve reinforcement ribs 7 and upper end surfaces of the sleeve butting plates 9 are flush with an upper end surface of the sleeve 3, and lower surfaces of the sleeve tie plates 5 are not flush with lower end surfaces of the sleeve 3. A distance from the lower surface of the sleeve butting plate 5 to a lower end of the sleeve 3 is not less than 300 mm.

The grid chord tie plates 4 are connected to the sleeve tie plates 5 through the tension bolts 13. The grid chord tie plates 4 are provided with first bolt holes 15 in fit with the tension bolts 13, and the sleeve tie plates 5 are provided with second bolt holes 17 in fit with the tension bolts 13.

As the sleeve tie plate 5 is welded to the surface of the sleeve 3, a distance from a center of a bolt hole of the sleeve butting plate 9 to an outer surface of the sleeve 3 is equal to a distance from a center of a bolt hole of the grid chord butting plate 8 to an outer surface of the grid chord 1 minus a wall thickness of the sleeve 3.

The grid chord butting plates 8 are connected to the sleeve butting plates 9 through splicing plates 10.

Each splicing plate 10 is provided with a plurality of longitudinal long slotted holes 14. Specifically, Each splicing plate 10 is provided with four long slotted holes 14.

Each grid chord butting plate 8 is provided with two bolt holes in fit with the longitudinal long slotted holes 14, and each grid chord butting plate 8 is connected to the longitudinal long slotted holes 14 in a corresponding one of the splicing plate 10 through high-strength bolts 12. Each sleeve butting plate 9 is provided with two bolt holes in fit with the longitudinal long slotted holes 14, and the sleeve butting plates 9 are connected to the longitudinal long slotted holes 14 in a corresponding one of the splicing plates 10 through high-strength bolts 12.

A length of the splicing plate 10 is approximately sum of the heights of the sleeve butting plate 9 and the grid chord butting plate 8, the similar height can save time for the positioning of the bolt holes, and can also play a role in bearing the bending moment and shear force in assembled joints.

A construction method for a connection joint of closure of a space grid and a truss structure of the present invention includes the following steps:
S1. A sleeve 3 is sleeved on an end of a truss chord 2, one-sided bolts 11 pass through bolt holes in the sleeve 3 and circumferential long slotted holes 16 in the truss chord 2 and then are preliminarily tightened at an outer side, thus the sleeve 3 and the truss chord 2 are connected together.
S2. The sleeve 3 is rotated through circumferential long slotted holes 16 in the sleeve 3, such that a first bolt 15 in each grid chord tie plate 4 and a second bolt hole 17 in each sleeve tie plate 5 are located in a straight line, thus a construction error of the grid chord 1 and the truss chord 2 in a circumferential direction is eliminated.
S3. Tension bolts 13 pass through the first bolt holes 15 in the grid chord tie plates 4 and the second bolt holes 17 in the sleeve tie plates 5, and then are tightened to achieve longitudinal butting of the grid chord 1 and the truss chord 2.
S4. High-strength bolts 12 pass through longitudinal long slotted holes 14 in splicing plates 10, bolt holes in grid chord butting plates 8 and bolt hole in sleeve butting plates 9, and then are tightened. The long longitudinal slotted holes 14 in the splicing plate 10 are used to adapt to a construction error of the grid chord 1 and the truss chord 2 in a longitudinal direction, thus reinforced butting of the grid chord 1 and the truss chord 2 is achieved.

The above embodiments are only the description of the preferred mode of the present disclosure, and are not intended to limit the scope of the present disclosure. Various modifications and improvements made by those of ordinary skill in the art to the technical solution of the present disclosure without departing from the design spirit of the present disclosure shall fall within the scope of protection determined by the claims of the present disclosure.

1. A connection joint of closure of a space grid and a truss structure, comprising:
a grid chord,
a truss chord, and
a sleeve,
wherein the sleeve is sleeved on the truss chord, a circumferential surface of the truss chord is provided with circumferential long slots in fit with the sleeve, and the sleeve is connected to the circumferential long slots through one-sided bolts; grid chord tie plates are welded to the grid chord, and grid chord butting plates are welded to right ends of the grid chord tie plates; sleeve tie plates are welded to the sleeve, and sleeve butting plates are welded to right ends of the sleeve tie plates; and the grid chord tie plates are connected to the sleeve tie plates through tension bolts, and the grid chord butting plates are connected to the sleeve butting plates through splicing plates.

2. The connection joint of closure of the space grid and the truss structure according to claim 1, wherein each splicing plate is provided with a plurality of longitudinal long slots, each grid chord butting plate is provided with bolt holes in fit with the longitudinal long slots, and each grid chord butting plate; is connected to the longitudinal long slots in a corresponding one of the splicing plates through high-strength bolts; each sleeve butting plate is provided with bolt holes in fit with the longitudinal long slots, and each sleeve butting plate is connected to the longitudinal long slots in a corresponding one of the splicing plates through the high-strength bolts.

3. The connection joint of closure of the space grid and the truss structure according to claim 1, wherein grid chord reinforcement ribs are welded to left ends of the grid chord tie plates, and sleeve reinforcement ribs are welded to left ends of the sleeve tie plates.

4. The connection joint of closure of the space grid and the truss structure according to claim 1, wherein the grid chord tie plates are provided with first bolt holes in fit with the tension bolts, and the sleeve tie plates are provided with second bolt holes in fit with the tension bolts.

5. The connection joint of closure of the space grid and the truss structure according to claim 1, wherein the grid chord tie plates are fan-shaped, four grid chord tie plates are circumferentially welded to a circumferential surface of the grid chord with an angle of 90° between each two adjacent grid chord tie plates; and the sleeve tie plates are fan-shaped, four sleeve tie plates are circumferentially welded to the sleeve with an angle of 90° between each two adjacent sleeve tie plates.

6. The connection joint of closure of the space grid and the truss structure according to claim 1, wherein each splicing plate is provided with four longitudinal long slots.

7. The connection joint of closure of the space grid and the truss structure according to claim 3, wherein the grid chord reinforcement ribs and the grid chord butting plates are trapezoidal, and the grid chord reinforcement ribs and the grid chord butting plates are vertically welded to left and right ends of the grid chord tie plates, respectively; and the sleeve reinforcement ribs and the sleeve butting plates are trapezoidal, and the sleeve reinforcement ribs and the sleeve butting plates are vertically welded to left and right ends of the sleeve tie plate, respectively.

8. The connection joint of closure of the space grid and the truss structure according to claim 1, wherein an outer diameter of the grid chord is the identical with an outer diameter of the truss chord, and an inner diameter of the sleeve is greater than an outer diameter of the truss chord.

9. The connection joint of closure of the space grid and the truss structure according to claim 3, wherein lower end surfaces of the grid chord reinforcement ribs and lower end surfaces of the grid chord butting plates are correspondingly welded to upper surfaces of the grid chord tie plates, and lower surfaces of the grid chord tie plates are flush with a lower end surface of the grid chord; lower end surfaces of the sleeve reinforcement ribs and lower end surfaces of the sleeve butting plates are correspondingly welded to upper surfaces of the sleeve tie plates; upper end surfaces of the sleeve reinforcement ribs and upper end surfaces of the sleeve butting plates are flush with an upper end surface of the sleeve, and lower surfaces of the sleeve tie plates are not flush with a lower end surface of the sleeve.

10. A construction method for the connection joint according to claim 1, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord R and the truss chord.

11. A construction method for the connection joint according to claim 2, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

12. A construction method for the connection joint according to claim 3, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

13. A construction method for the connection joint according to claim 4, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

14. A construction method for the connection joint according to claim 5, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

15. A construction method for the connection joint according to claim 6, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

16. A construction method for the connection joint according to claim 7, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

17. A construction method for the connection joint according to claim 8, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.

18. A construction method for the connection joint according to claim 9, comprising the following steps:
S1, sleeving the sleeve on an end of the truss chord, wherein the one-sided bolts pass through the bolt holes in the sleeve and the circumferential long slots in the truss chord and then are preliminarily tightened at an outer side to connect the sleeve and the truss chord together;
S2, rotating the sleeve through the circumferential long slots in the sleeve, making the first bolt holes in the grid chord tie plates and the second bolt holes in the sleeve tie plates in a straight line, thus eliminating a construction error of the grid chord and the truss chord in a circumferential direction;
S3, enabling the tension bolts to pass through the first bolt holes in the grid chord tie plates and the second bolt holes in the sleeve tie plates, and then tightening the tension bolts to achieve longitudinal butting of the grid chord and the truss chord; and
S4: enabling the high-strength bolts to pass through the longitudinal long slots in splicing plates, the bolt holes in the grid chord butting plates and the bolt holes in the sleeve butting plates, and then tightening the high-strength bolts, wherein the longitudinal long slots in the splicing plates are configured to accommodate a construction error of the grid chord and the truss chord in a longitudinal direction, thus achieving reinforced butting of the grid chord and the truss chord.
